(19) United States
(12) Patent Application Publication
(10) Pub. No.: US 2009/0083232 A1
(43) Pub. Date: Mar. 26, 2009

(54) SEARCH RESULTS WITH SEARCH QUERY SUGGESTIONS

(75) Inventors: Stephen Ives, Cambridge (GB); Stefan Butlin, Cambridge (GB)

Correspondence Address: BARNES & THORNBURG LLP, P.O. BOX 2786, CHICAGO, IL, 60690-2786, US

(73) Assignee: TAPTU LTD., Cambridge (GB)

(21) Appl. No.: 12/236,106

(22) Filed: Sep. 23, 2008

Related U.S. Application Data
(60) Provisional application No. 60/974,534, filed on Sep. 24, 2007.

(51) Int. Cl. G06F 17/30

(52) U.S. Cl. 707/3; 707/E17.014

(57) ABSTRACT

A search service provides a set of search results (420) in response to a search query from a user, and provides one or more suggested search queries (430), for selection by the user to generate more search results, at least one of the suggested search queries having a correspondence with a corresponding subset of one or more of the search results. The set of search results are sent with an indication of the corresponding suggested search queries, for presentation to the user with a visual representation of the correspondence. Such a visual representation can mean locating the suggested search query adjacent to its corresponding search result, and can enable a user to select an appropriate further search query more quickly with a minimum of clicks, or less time for a user reviewing less relevant information or more efficient use of screenspace.

### RELATED APPLICATIONS

This application claims the benefit of earlier filed provisional application Ser. No. 60/974,534 filed 24^{th} Sep. 2007 entitled “METHOD OF PERFORMING MULTIPLE RELATED SEARCHES”.

This application also relates to five earlier US patent applications, namely Ser. No. 11/189,312 filed 26 Jul. 2005, published as US 2007/00278329, entitled “processing and sending search results over a wireless network to a mobile device”; Ser. No. 11/232,591, filed Sep. 22, 2005, published as US 2007/0067267 entitled “Systems and methods for managing the display of sponsored links together with search results in a search engine system” claiming priority from UK patent application no. GB0519256.2 of Sep. 21, 2005, published as GB2430507; Ser. No. 11/248,073, filed 11 Oct. 2005, published as US 2007/0067304, entitled “Search using changes in prevalence of content items on the web”; Ser. No. 11/289,078, filed 29 Nov. 2005, published as US 2007/0067305 entitled “Display of search results on mobile device browser with background process”; and U.S. Ser. No. 11/369,025, filed 06 Mar. 2006, published as US2007/0208704 entitled “Packaged mobile search results”. This application also relates to provisional applications:
Ser. No. 60/946,728 filed 28 Jun. 2007 entitled “Ranking Search Results Using a Measure of Buzz”,
Ser. No. 60/946,730 filed 28 Jun. 2007 entitled “Social distance search ranking”
Ser. No. 60/946,729 filed 28 Jun. 2007 entitled “Method of Enhancing Availability of Mobile Search Results”,
Ser. No. 60/946,727 filed 28 Jun. 2007 entitled “Managing Mobile Search Results”,
Ser. No. 60/946,726 filed 28 Jun. 2007 entitled “Audio Thumbnail”
Ser. No. 60/946,731 filed 28 Jun. 2007 entitled “Festive Mobile Search Results”.

The contents of these applications and provisional applications and all their corresponding non provisional applications are hereby incorporated by reference in their entirety.

### FIELD OF THE INVENTION

This invention relates to methods of providing a computer based search service to send search results in response to a search query, and to a server arranged to provide search results in response to a search query, and to methods of using a search service to receive search results, and to corresponding apparatus or software.

### DESCRIPTION OF THE RELATED ART

A good search tool enables general purpose access to an information store such as the world wide web. Searching the world wide web is a well solved problem when accessing the web from a desktop personal computer (e.g. search services provided by Google Inc. and others). Mobile devices that are capable of accessing content on the world wide web are increasingly numerous. However, pages designed specifically for the small screen sizes of mobile devices are very few. Further, there are only a few very simple search services available to mobile devices. These search services perform poorly for several reasons:
there are not enough mobile-specific pages available today to provide relevant pages for most search queries (although this is changing as more mobile-specific web sites are created)
desktop-specific webpages cannot be easily rendered on the limited screen and limited browsers of mobile devices,
direct translation of desktop-specific webpages to the specific markup language supported by most mobile devices (eg XHTML Basic and XHTML Mobile Profile ) is a hard problem, and
network requests suffer high latency regardless of the high bandwidths increasingly available, this means every click by a user on a link takes several seconds for a response regardless of the size of the response.

The information held in the world wide web is therefore very hard to access from a mobile device and particularly from a handset with a small screen.

When making use of a search engine from a mobile device, a user must often enter multiple search terms to achieve the desired accuracy of results. Further, a single search is rarely sufficient, and the user must iterate the set of search terms, performing repeated searches as they home in on the results they are looking for. On a mobile device input methods are often awkward and time consuming, the time taken therefore to enter multiple search terms and for multiple searches is therefore a real problem.

Search results are typically a page of links to candidate pages. Sometimes these links are accompanied by snippets of text from the candidate pages to assist the user in determining relevancy. The user must then click on these links in turn, possibly skipping seemly irrelevant links, in order to test or check whether the linked page contains the desired information.

This process works fine for a search when using a desktop personal computer connected using a good dial-up or broadband internet connection. It works less well for a mobile device. Search engines for use from mobile devices can be arranged to use conventional browsers on mobile devices, for displaying web pages (for example Google™ mobile), or a custom client application can be installed by the user on their mobile device to run instead of the browser (for example Nokia “mobile search application”) so that search results need not be sent in web page format. The browser-based mobile search engines enable use from a wider range of different devices, but operation is slower. The slower network bandwidth and much higher connection latencies of a wireless network means each click to download a page takes at least 2-3 seconds and sometimes several seconds. Google™ Mobile sends less information about each hit in the search results, than its standard search, and uses transcoding of web pages to fit smaller screens typical of handheld devices. This reduces the amount of data sent over the wireless network, but is only partially successful and still suffers high latencies. The search results are still sent as a single page with a list of results including approximately 10 to 20 words as a summary for each result in the list. Testing ten or twenty pages, a typical number required to find target information, can therefore take many minutes. Further, both the list of results and each target page are still larger than the small displays of many handheld mobile devices and so must usually be scrolled (often slowly by the limited capabilities of browsers found on handheld mobile devices) line by line, since the keypads of handheld mobile devices typically have no page up or page down keys. On conventional browsers, once a results page has been downloaded to a browser for display, the dialogue with the server is completed. To alter or update the page being displayed usually needs the browser to send a new page request to the server, the server to send the new page as XHTML, and the browser to interpret the received XHTML to display the page. Hence where a number of iterations of the search query is needed, the mobile search user experience is very poor and solutions already marketed have very low usage.

This has led to custom application-based mobile search engines to address the slowness, and improve the user experience. The custom application enables faster download since little or no page formatting information need be sent compared to the XHTML pages needed for browser-based searching. Interaction with the search results is no longer limited to scrolling the current page or downloading a new page. The user has the inconvenience of having to download and install the custom application and keep it updated. The search engine provider has the inconvenience of providing versions of such a custom application for a range of different mobile devices and managing updates for the many versions.

It is also known to try to improve speed of search by providing suggestions of further search queries for the user to select, which can save the user the time used in typing in all the characters of the query. Such suggested search queries can involve suggesting or predicting how to complete a partially entered search query, or providing suggestions of alternative complete search queries. These suggested search queries can be displayed to the user alongside the search query entry text box, in a drop down menu for example, or as a list in a separate frame. Some search services, e.g. Ask.com and more recently Google.com, have been offering alternative/related searches as single clicks on their result pages, however, on a mobile device there is limited room for the display of such links as well as the main results list, and further, there are often many tens, possibly hundreds, of related searches that might be relevant to the current search term.

### SUMMARY OF THE INVENTION

Amongst others, an object of the invention is to provide improved searching. Various aspects of the invention are set out in the independent claims. Dependent claims and embodiments provide various subsets within the scope of the independent claims. Many others are possible. Some are based on a recognition of the drawbacks of known arrangements, and/or a recognition that claimed features can provide advantages. Some are notable for providing a set of search results in response to a search query from a user, providing one or more suggested search queries, for selection by the user to generate more search results, at least one of the suggested search queries having a correspondence with a corresponding subset of one or more of the search results, and sending to the user the set of search results, with an indication of the corresponding suggested search queries, for presentation to the user with a visual representation of the correspondence.

Such a visual representation of the correspondence can enable a user to select an appropriate further search query more quickly since the visual representation of the correspondence can easily provide a clue to guide the user towards more relevant or appropriate suggested search queries with a minimum of clicks, or less time for a user reviewing less relevant information and with more efficient use of screenspace. This can enable a user to see from a limited number of results, which are not relevant and thus avoid the need to review suggested search queries which are likely to be less relevant. Aspects of the invention provides software, systems (meaning software and hardware to run the software) or an exchange of signals with users, to provide a search service for finding online content. It can be arranged to send search results to a user, and associated with each result prompt the user to select one or more links that perform new searches that are related to that result.

Another aspect of the invention, provides a search service for finding online content, arranged to send search results to a user as a collection of richer result previews, and associated with each result preview, prompt the user to select one or more links that perform new searches that are related to that result.

Numerous variations and modifications can be made without departing from the claims of the present invention. Therefore, it should be clearly understood that the embodiments of the present invention described in detail are illustrative only and not intended to limit the scope of the claims of the present invention.

### BRIEF DESCRIPTION OF THE DRAWINGS

How the present invention may be put into effect will now be described by way of example with reference to the appended drawings, in which:

FIG. 1 shows schematically an overview of some of the principal entities involved in an embodiment of the invention,

FIG. 2 shows some principal actions of a service provider according to an embodiment,

FIG. 3 shows some principal actions of a mobile device of a user, according to an embodiment,

FIG. 4 shows a schematic view of a mobile device screenview to show how search results can be presented with a visual representation of correspondence to suggested search queries, according to an embodiment,

FIG. 5 shows a schematic view of a sequence of mobile device screenviews according to another embodiment in which a separate screenview is used for the suggested search queries, or providing the opportunity for the user to select a category for the suggested further search queries,

FIG. 6 shows a schematic view of a sequence of mobile device screenviews according to another embodiment in which search result titles are shown on a first page, and user selection results in presentation of a further page having more details and corresponding suggested search queries,

FIG. 7 shows an overview of some principal entities of a search engine system, according to an embodiment,

FIG. 8 shows a schematic view of a sequence of mobile device screenviews according to another embodiment in which the suggested search queries are incorporated into a source webpage by a proxy server,

FIG. 9 shows a schematic view of a sequence of mobile device screenviews according to another embodiment in which the suggested search queries are incorporated into a source webpage by a proxy server, and appear as highlighted phrases in the source text

FIG. 10 shows an overview of some principal entities of a search engine system, according to an embodiment,

FIG. 11 shows some principal actions of a service provider according to an embodiment involving generating a proxy of a source web page.

FIG. 12 shows an example of steps involved in generating suggested search queries according to an embodiment,

FIG. 13 shows steps involved in providing a search service according to other embodiments involving sending a multipage package, and

FIG. 14 shows steps involved in using the service of FIG. 13.

### DETAILED DESCRIPTION

### Definitions:

“Search results” are defined to encompass for example any of: a list of web site or WAP site names or titles, a list of web site or WAP site URLs, a number of summaries of content items of web sites, in text or other media formats, audio, image, video and other media content items, or combinations of these or other content items in any format.

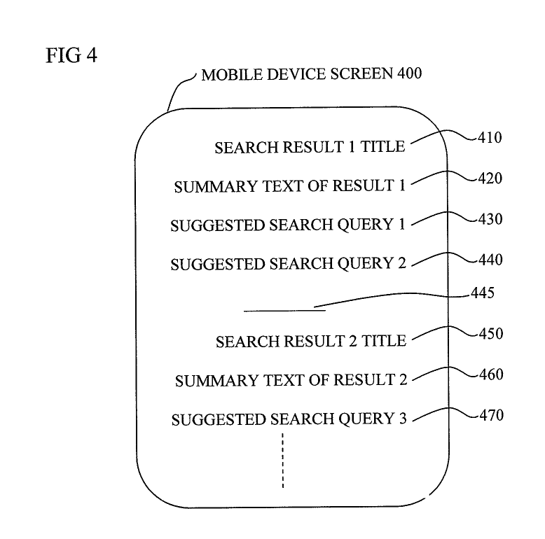

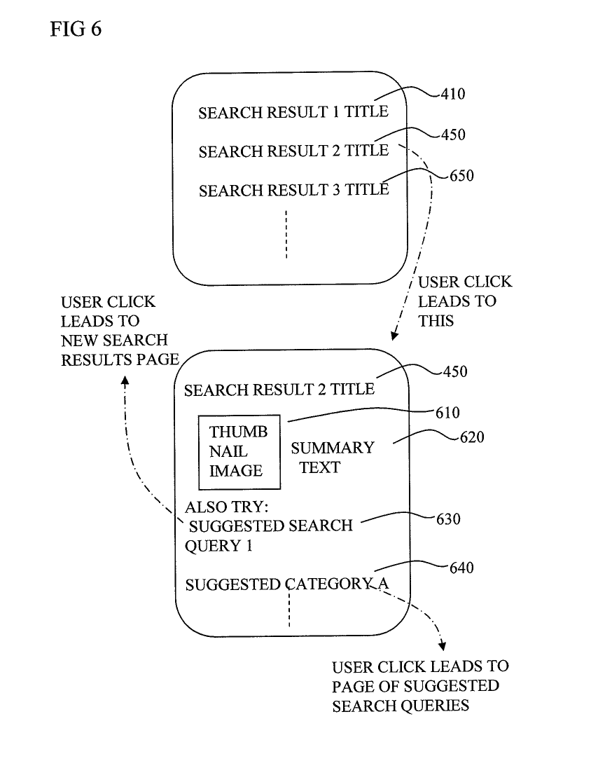

A package is defined as a group of pages capable of presentation by a browser and grouped in any way suitable for downloading together or in portions, in response to a single command. An example of a package is referred to below as a content summary package (CSP) and a multipart MIME (Multipurpose Internet Mail Extensions) CSP described below with reference to FIGS. 4 and 6 is an example of a package, and other equivalents can be envisaged.

A page is defined as any information capable of interpretation and presentation by a browser as a page, and can include HTML or XHTML or WAP pages for example.

“Presenting” is intended to encompass displaying text or images, playing of audio or video media, and playing of an audio representation of text for example.

The term “browser” is intended to encompass software for retrieving and presenting items that are accessible online such as web or WAP pages in a mark up language, and encompasses microbrowser applications.

“Link” is intended to encompass for example a clickable object on the screen (e.g. in HTML, usually an underlined piece of text that has an associated URL that will be loaded when it is clicked) that causes a change in the user interface, the change being for example any of: loading a new page, displaying a popup, displaying a menu and so on. A link can also be referred to as a “clickable object” or “selectable object” or “activatable object”.

A knowledge base having articles grouped by category is intended to encompass at least: any list, database or store of information or store of objects, (whether stored local to the system or exposed via a remote service), where each object has a name and a list of one or more categories to which the object belongs. Wikipedia™ is an example of a store of articles in the form of pages having page titles and each article is assigned to one or more wiki categories. IMdB™ is a movie related example where each movie can be regarded as an article and be categorized by genre or by cast member for example (or the cast members can be articles categorized by what movie they starred in for example). MusicBrainz™ is a music example providing articles such as artists, or songs or albums (again it is interchangeable which are considered as the articles and which are their “categories”, e.g. an article can be an artist, which can be used to find an associated category such as their albums, and this can lead to new articles from the same category, such as songs from those albums).

“Online content” is defined to encompass at least a web page, a WAP page, an extract of text, a news item, an image, a sound or video clip, an interactive item such as a game, and many other types of content for example. “Online” is defined to encompass at least items in pages on websites of the world wide web, items in the deep web (e.g. databases of items accessible by queries through a web page), items available internal company intranets, or any online database including online vendors and marketplaces.

A “keyword” can encompass a text word or phrase, or any pattern including a sound or image signature.

“Hyperlink” is defined to encompass at least hypertext, buttons, softkeys or menus or navigation bars or any displayed indication or audible prompt which can be selected by a user to present different content.

The term “subject category” is intended to encompass categories of subject matter of content items, for example where a query term has a number of meanings or contexts or will produce a number of clusters of related results.

The term “comprising” is used as an open-ended term, not to exclude further items as well as those listed.

The term “wireless network” is intended to encompass cellular networks, GSM networks, GPRS networks, UMTS networks, WiFi networks and other wireless networks having potential for delays which are noticeable or inconvenient to a user browsing search results. The wireless network can encompass combinations of the above networks, and ultra wide band WiFi and meshed WiFi (arranged in a wireless mesh where each hop between base stations adds cumulative delay).

In some embodiments, the package comprises a multipart MIME document. MIME (Multipurpose Internet Mail Extensions) is a standard which is supported by a wide range of handheld devices and so helps enable the service to be widely accessible. This can keep down the costs for the service provider of maintaining different versions of the service to suit different devices.

### Additional Features:

The embodiments described below show examples of search services involving providing one or more suggested search queries, for selection by the user to generate more search results, at least one of the suggested search queries having a correspondence with a corresponding subset of one or more of the search results, and sending to the user the set of search results, with an indication of the corresponding suggested search queries, for presentation to the user with a visual representation of the correspondence. Any additional features may be added, and some additional features are described by way of example and are the subject of dependent claims.

An additional feature is providing the service to a mobile device of the user, and the step of causing the presentation to the user comprising causing the mobile device to present to the user. In other cases devices other than mobile devices can be used to access the service. Another such additional features is providing a web based search service, and the step of causing the presentation to the user comprising sending a page to be rendered by a browser running on a computing device of the user.

The visual representation of the correspondence can involve placing suggested search queries adjacent to their corresponding search result. This can make the correspondence easier to see, and enable a user to find the more relevant suggested search queries more easily than if these queries are presented in a plain list for example.

The sending of the search results can be for presentation on separate screenviews, and the corresponding suggested search queries be placed on the same screenview as their corresponding search result. This can enable more screen space to be used for each of the results and the suggested search queries, to provide more information, though more navigation clicks may be needed.

In some cases the correspondence can be determined by determining whether the search query was derived from the search result, or derived from a source of the result. In other cases it can involve determining whether the suggested search query is based on a subset of the topics of the search result, or whether the respective topics of the suggested search queries and the search result have any common root.

The suggested search queries can be generated in some cases by using a knowledge base having articles grouped by category, to find articles mentioning a topic of the search result, determining from the knowledge base which categories these articles belong to, then determining a number of new articles also belonging to selected ones of these categories, and selecting suggested search queries from the subject matter of these new articles.

The indication of corresponding suggested search queries can comprise a link selectable by the user to lead to presentation of a group of suggested search queries. This can enable more screen space to be used for the suggested search queries for example.

The step of generating suggested search queries can involve selecting a portion of text from the corresponding search result.

The visual representation of the correspondence can comprise text of the search result with the selected portion or portions of the text in their original position in the text and highlighted so as to indicate that the portion is selectable by the user to cause a further search. This can save screen space and show the query in context, so making it easier for the user to focus on relevant queries, but limits the queries to text already there.

The step of sending the search results to the user can involve retrieving source content of the given result, and sending to the user a proxied version of the source content, the proxied version being altered to incorporate corresponding ones of the suggested search queries. This can enable the user to review more information to enable them to focus their search, and means the source content will be up to date.

Some embodiments provide a method of using a mobile search service having the steps of: sending a search query to the mobile search service, receiving at a browser running on a mobile device, a package containing more than one page defined by a mark up language, the pages containing search results corresponding to the search query, and using the browser to selectively present the pages.

As discussed above, at least some of the embodiments are based on a realization that it is possible to improve the time a user of a mobile device spends entering search terms by offering suggested search queries as additional links within search results that perform new searches, where these links are visually associated each result, and where the new search query is in some way related to its associated result. Clicking on such links therefore saves the user the time it would take to enter the new search terms. Additionally, by using contextual or other meta-data, these links can be used to perform refinements or related searches that cannot be expressed simply as a new collection of search terms.

This idea is an improvement on existing suggested search queries (also known as related search links), as the new search links are presented per-result and are specific to and or related to that result—depending on the visual arrangement and pagination of the results, there is therefore scope to offer many more related search options.

In some embodiments of this invention, a search service is made available to mobile handsets. A home page is the default starting page and offers the typical input box and search button. When one or more input terms are submitted, the search engine returns a collection of initial results. These results are first displayed as a concise list of links which point to a richer preview page per result. An example of such an arrangement is described in some detail in the above referenced preceding application by the present applicants, entitled PACKAGED MOBILE SEARCH RESULTS. Within these result preview pages, in addition to the usual source-site link offered to the user, additional links are offered that perform new searches. The search terms that will be submitted to the host search service are those that are presented as the link words. Whilst these links could appear as normal links (for example, the widely used blue text with blue underline), it can be clearer to the user what will happen if a different visual convention is adopted for the display of such related-search links—thus differentiating “off-site” links with “new search” links.

In another embodiment of this invention, the related searches are refinements of the original terms. For example, searching for the term “Chelsea” might yield a result about Chelsea Football Club. The preview for this result could offer new searches for either “Chelsea Football Club” and or “Chelsea FC”. The same result is likely to show up again, however, in addition, the user might now get several results pertaining to the football club and no longer get results pertaining to the London borough or personal names such as the daughter of a former US president (Chelsea Clinton). Further, the result preview for Chelsea football club might present a list of players as part of the preview, and each of these player names could itself be a new search link for that player.

In another embodiment of this invention, the context of previous searches is maintained when performing new related searches. Thus in the Chelsea FC example of the previous paragraph, clicking on a player name could perform a new search on that player name and in the context of any of Chelsea FC, Football, or even Sport in general. This means the new result list can be pre-filtered for sport results, football results or Chelsea FC specific results—all without the user needing to specify the constraining of the search to the topic of sport, or supplying additional terms in an attempt to limit the scope of the new search.

In another embodiment of this invention, the related searches are performed on a 3rd party search service. For example, if searching for a song, the result preview for the desired song might offer links which perform searches on dedicated song-search services. The term given to the 3rd party service would in this case be the artist name appended with the song name, thereby clearly identifying the song to search for on the external service without the user needing to navigate there and type in the long term manually.

In another embodiment of this invention, result preview pages are not used, but each result link is a link to the real source site. However, instead of sending the user off-site to the source site, the search service proxies the source site. In the context of this invention, this lets the search service alter the source site page to include new search links on any keywords or phrases it chooses. For example, every heading in the source site could be used as a new search term, or every link could be converted from its original connection to instead perform a new search. Still other schemes here might look for words or phrases that exist in a lexicon stored on the search service. For example, if the search service is used primarily as a music search engine, then all occurrences of artist names in the text of source sites could be converted to be links to new searches. It is expected that the alteration of the source page would include inserting means to revert to the real source page and not the proxied version.

The present invention is not limited to mobile search services. The benefits of one-click initiation of new searches, and those of offering result-specific alternative searches, apply to any situation where either display space or input methods are constrained. For example, if a search service is being embedded in another desktop website or application, then its display area may be limited such that grouping alternative searches by result would make it easier to find and select such alternatives. Another example might could be a kiosk situation where a touch screen is being used to control a browser. Here, there is rarely a convenient keyboard with which to quickly type new searches, and hence the obvious benefit in having clickable alternative searches.

The present invention is not limited to performing “refinements” of the original search. While the related searches offered in a result preview are related to the current result, the new searches do not have to be related to the original search term. For example a user searches on Jay Leno (chat show host) to find out when the Jay Leno show originally aired, he chooses the Wikipedia result for Jay Leno and finds the term ‘Michael Jackson trial’ as a Wiki entry heading. Previously the user was not aware that Jay Leno was linked to the trial. Now he could use this result as a basis for a new search on ‘Michael Jackson trial’ simply by clicking on a link, without having to enter a new search team. This new search is related in some way to the original search, but is not a refinement of it. In this way, users can navigate from search to search knowing that they only need to seed the session with the simplest and most tenuously connected search term.

References herein to “related” searches are intended to be interpreted very broadly. The new search links might be simply the linking of any piece of text associated with the current search result, or it could a term found in meta-data associated with the current search result, or it could be in some way deduced or derived from the text and/or metadata associated with the current result. How related the new search terms are therefore, depends on the quality of the search result; if the result is very specific to the original search and contains only concise and accurate text, then any new search link is very likely to be highly related to the original search and the topic of that result; alternatively, if the result is very unspecific and contains verbose descriptions of topics maybe only one of which loosely pertains to the original search term, then any new search links are very likely to unrelated, or only tenuously related, to the original search and the topic of the current result.

The description herein of embodiments of present invention also frequently refers to the association of new search links with search results. Again, the term “association” is used very broadly, and its meaning depends on how the results of the original search are presented to the user. Where results are presented on a single page, each result is typically one or more lines of text (and/or some images) which are visually grouped to separate them from the next search result on the page. In such cases, the intention is to treat any new search links that are within that visual grouping as being associated with that search result. At the other extreme, where results are presented with whole-page previews or summaries, then the intention is to treat any new search links that are within such summary pages as being associated with that search result.

In one embodiment of this invention, selecting a new search link causes the service to perform a new search, as if the user had entered the search terms in the original input box themselves. The effect of selecting such new search links is therefore to be taken to a new page of search results, this time pertaining to the term or terms supplied by the new search link. However, other embodiments of the present invention can involve alternative treatments whereby the new search results are arranged to appear as derivative, perhaps within a popup window (if the display and software platform support such features), or perhaps as a new list which is drawn as if the original search result was a folder that has now been opened to reveal a “contained” set of results, or perhaps a new listing page is used but with extra context information displayed such as the sequence of searches which have been performed to reach the current page (“search breadcrumbs”). Also as mentioned previously in this description, the new search might preserve some additional context of the original search and thereby help control the relevance of the new results in a way that could not be achieved with terms entered in the starting input box.

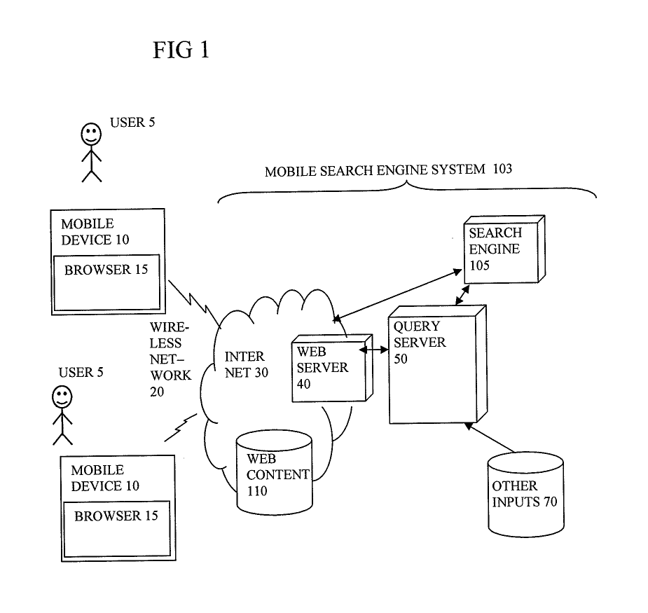

### FIG. 1, Overall Topology

The overall topology of a first embodiment of the invention is illustrated in FIG. 1. FIG. 1 shows the Internet 30, and two mobile devices 10 of end users 5, coupled to the internet over a wireless network 20, and having browsers 15. In principle, the mobile devices could be coupled to other applications, for example in car computers with voice interfaces to enable users to search and obtain information from the web while driving. In FIG. 1, cylinder symbols represent stored information such as databases which may be implemented on a hard disc or in semiconductor memory for example, and may be distributed or local, and may be managed with appropriate back up and access security, following established practice. Cuboid shapes in this figure represent processes which may run as application software on their own server or be distributed or may share a server for example.

The search query is typically one or more keywords sent by the browser to the known internet address (URL) of the query server. It is sent as a request and is sent via a conventional protocol stack in the mobile device to enable communication over the wireless communications network. The protocol stack typically comprises the standard WAP or TCP/IP protocols which allow the mobile device to communicate with internet hosts and the transport and physical layer protocols, for example GPRS or the third generation UMTS protocols, that enable the mobile terminal to access and communicate data over the wireless communications network. The mobile terminal establishes a communications link to a WAP gateway or network access server (NAS) that interfaces the wireless network to the internet and routes the browser's request across the internet to the mobile search engine system 103. Web content (110) can include for example web pages, WAP pages, microformats (chunks of XML encapsulated by a web or WAP pages to describe items such as calendar events or other objects), RDF (resource description format) files (XML files relating to the semantic web to define relationships between information on pages), RSS feeds, and other web content.

The system comprises a number of elements as shown. A query server 50 is coupled to the internet via a web server 40. The query server passes the query to a search engine 105.

Optionally the query server can operate as a front end only, in which case it could select a search engine of another organization at a remote location, which would use a content summariser and store of content summaries of that other organization or location. The functions remain similar wherever they are carried out or by which ever organization. Optionally the query server can be located at the interface between the wireless network and the internet, and be part of a service provided by the wireless network operator. The relevant content summaries are returned to the query server and formed into a package suitable for browsing on the mobile device of the user. Other inputs 70 are fed from a store to the query server for use in forming the package. Such other inputs can include advertising or news material for presenting to the user, or characteristics of the mobile device or its browser, characteristics of the wireless network channel, user location, user preferences and so on, for use in determining how much to send, and in what format and so on. These parts described form a mobile search engine system 103. The query server sends the package via the web server, the internet and the wireless network to the mobile user.

The system can be formed of many servers and databases distributed across a network, or in principle they can be consolidated at a single location or machine. The search engine can be consolidated with the query server in this case, and some, all or none of the back end parts used by the query server.

The users 5 connected to the Internet via mobile devices 10 can make searches via the query server. The users making searches (‘mobile users’) on mobile devices are connected to a wireless network 20 managed by a network operator, which is in turn connected to the Internet via a WAP gateway, network access server (NAS) or other similar device (using known principles and so not explained here in more detail). Many variations are envisaged, for example the content items can be elsewhere than the world wide web, and so on.

### Description of Mobile Devices

The user can access the search engine from a mobile device such as any kind of mobile computing device, including laptop and hand held computers portable music players, portable multimedia players. Mobile users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface. These devices can typically run web browsers or microbrowser applications e.g. Openwave™, Access™, Opera™ Mozilla™ browsers, which can access web pages across the Internet. These may be normal HTML web pages, or they may be pages formatted specifically for mobile devices using various subsets and variants of HTML, including cHTML, WML, DHTML, XHTML, XHTML Basic and XHTML Mobile Profile. The browsers allow the users to click on hyperlinks within web pages which contain URLs (uniform resource locators) which direct the browser to retrieve a new web page.

### Description of Servers

Although illustrated as a single server, the same functions can be arranged or divided in different ways to run on different numbers of servers or as different numbers of processes, or be run by different organisations.
The query server handles search queries from desktop PCs and mobile devices, passing them onto the other servers, and formats response data into web pages customised to different types of devices, as appropriate. Optionally the query server can operate behind a front end to a search engine of another organization at a remote location. Optionally the query server can carry out ranking of search results or this can be carried out by a separate ranking server. The query server is typically connected to a database that stores detailed device profile information on mobile devices and desktop devices, including information on the device screen size, device capabilities and in particular the capabilities of the browser or microbrowser running on that device. The database may also store individual user profile information, or individual profiles aggregated into group profiles, so that the service can be personalised to individual user or group needs. This may or may not include usage history information.

Web server programs can be separate or integral to the query server and other servers. These can be implemented to run Apache™ or some similar program, handling multiple simultaneous HTTP and FTP communication protocol sessions with users connecting over the Internet.

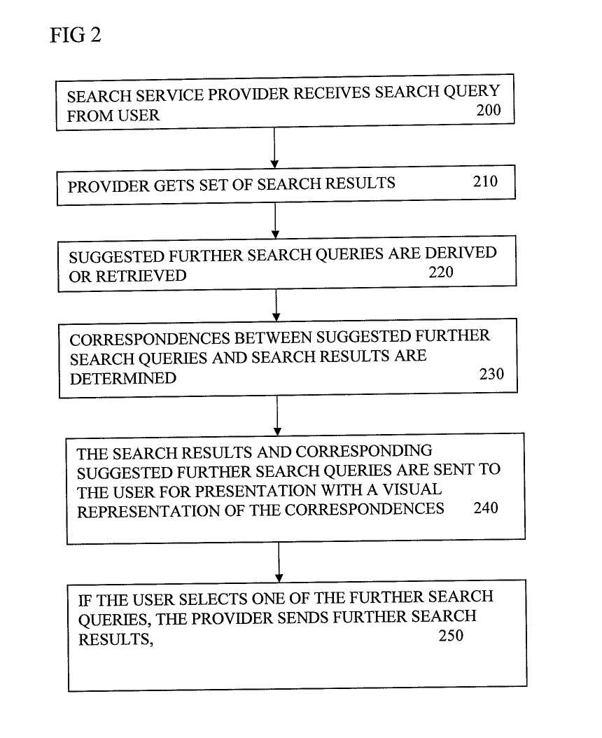

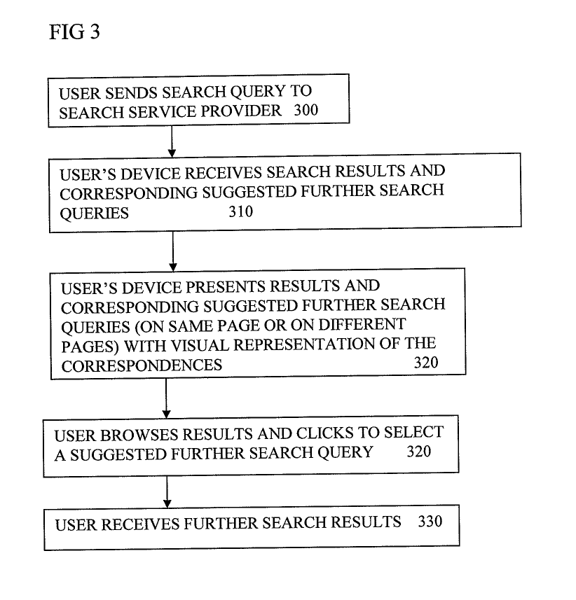

### FIGS. 2, 3 Operations:

Conventionally a user enters a query into the mobile device. The mobile device sets up a path for the query and response operation using e.g. WAP or TCP/IP protocols with the query server. This typically involves an exchange of many low level messages, adding to the delay or latency of the wireless network. This enables the keyword to be sent to the query server, which communicates with a search engine to return results in the form of titles, URLs and text extracts having the keywords. A page of these results in the form of an annotated list is sent to the mobile device. This download across the wireless network can cause additional delay. The results page is then displayed by the mobile device. A user can then select one of the results and click on it to cause the browser on the mobile device to send a URL request. This can be routed across the wireless network to a transcoding engine which will access the original web page corresponding to that URL, and reformat it into a form suitable for display on the screen of that mobile device. If this document is not quite what the user wants, the request and download process is repeated.

Some of the principal steps in providing a search service according to an embodiment are shown in FIG. 2. At step 200 the search service provider receives the search query from the user. At step 210 the provider gets the search results. As indicated above this can either involve a dedicated search engine or can use third party search engines for example. At step 220, suggested further search queries corresponding to the search results are derived. This can be carried out by the query server for example. At step 230, if necessary, correspondences between the queries and the search results are determined. At step 240 the search results and corresponding suggested further search queries are sent by the query server to the user for presentation with a visual representation of the correspondences. If the user selects one of the further search queries, the provider then carries out a further search and sends further search results at step 250.

FIG. 3 shows some of the principal steps in using such a search service, according to an embodiment. The user sends a search query to the search service provider at step 300. The user's device receives the search results and corresponding suggested further search queries at step 310. The user's device presents results and corresponding suggested further search queries (on same page or on different pages) with a visual representation of the correspondences at step 320. The user browses these results and clicks to select a suggested further search query at step 320, and the user receives further search results at step 330.

### FIGS. 4,5,6, User Device Screenviews

FIGS. 4, 5 and 6 show schematic views of screenviews of a mobile device of a user. The screenview 400 shows an example of a layout of some of the principal items displayed during presentation of search results sent by a search service. The various items are shown on different lines but could be in different windows, frames or columns for example. A search result title 410 is shown in a top line. A summary text of a first search result 420 is shown in a second line. A first corresponding suggested search query 430 is shown in a third line, adjacent to the first search result so that it is close enough to show that it corresponds to the first search result. A second corresponding suggested search query 440 is shown below the first suggested search query. A visual break is provided by line 445 to divide the screen into areas. A second area below the divide has a second search request title 450, followed by a summary text 460 of the second result, and a third suggested search query 470 which corresponds to the second search result. Of course there can be third and fourth or more search results in the same screenview, with their corresponding suggested search queries.

The suggested search queries are text phrases which are arranged as clickable links which will lead the search service to use that phrase as search keywords and will send further search results to the user.

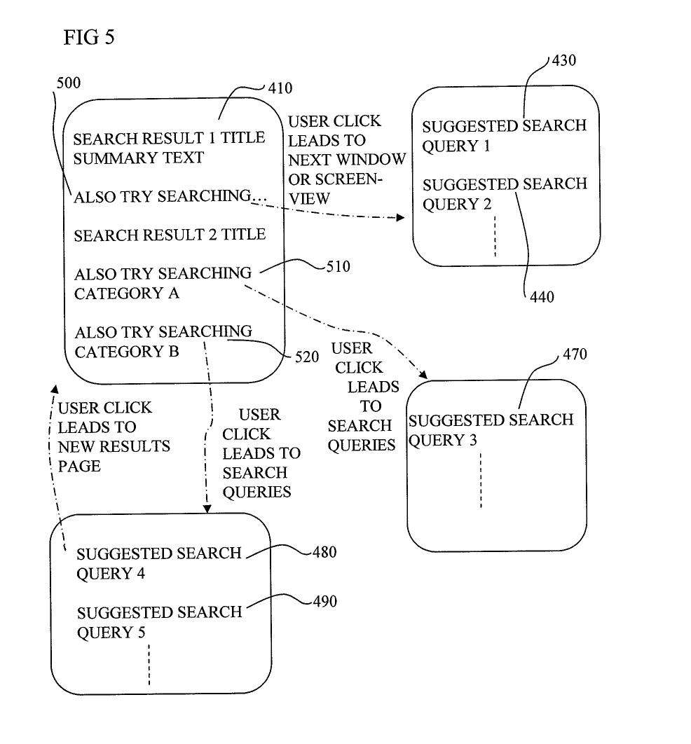

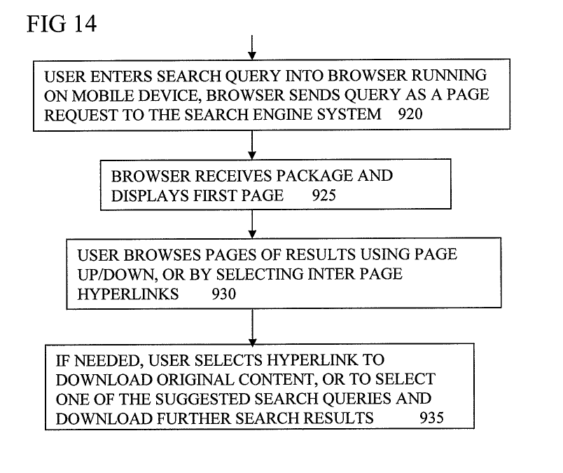

In the example of FIG. 5, a schematic view is shown of a sequence of mobile device screenviews according to another embodiment in which a separate screenview is used for the suggested search queries, or providing the opportunity for the user to select a category for the suggested further search queries. Starting from the first screenview shown at top left, user clicks on different links in that first screenview lead to the other screenviews, as shown by dashed line arrows. The first screenview shows a first search result title, a summary text, and an item 500 showing “also try searching . . . ”. This item is a link which leads to presentation of the screenview shown at top right. This screenview has any suggested search queries which correspond to the first search result. As shown a first line has a first suggested search query 430 and a second suggested search query 440, and perhaps others depending on size of the screenview. These further screenviews can be implemented as pop up windows or menus, and so on. The first and further screenviews can be downloaded together as a package without waiting to see which are selected, or each can be downloaded on demand only when they are selected. More details of examples of packages are described below with reference to FIGS. 13 and 14.

The first screenview also shows a second search result title, and a corresponding item 510 indicating “also try searching category A”. This is located adjacent to the second search result title or to a summary of the second search result, to show that it corresponds to the second search result. If the user selects this item, it leads to the screenview shown at bottom right, which shows any suggested search queries corresponding to the second search result, and belonging to category A such as the third search result as shown.

The first screenview also shows an item 520 indicating “also try searching category B”. This is also located close to the second search result title or to a summary of the second search result, to show that it corresponds to the second search result. If the user selects this item, it leads to the screenview shown at bottom left, which shows any suggested search queries corresponding to the second search result, and belonging to category B, such as the fourth 480 and fifth 490 search results as shown.

FIG. 6 shows a schematic view of a sequence of mobile device screenviews according to another embodiment in which search result titles are shown on a first page, and user selection results in presentation of a further page having more details and corresponding suggested search queries,

A first screenview shows a list of first, second and third search result titles 410, 450 and 650, and there may be more according to the size of the screenview. A user click on the second of these leads to the lower screenview. This shows a separate page or window for more details of a single search result. In this case there is the search result title 450 at the top, a thumbnail image 610, and summary text 620 providing more details than the title. Appended lower down are the corresponding suggested search queries. In this case a first suggested search query 630 is shown, and a suggested category A 640 is shown.

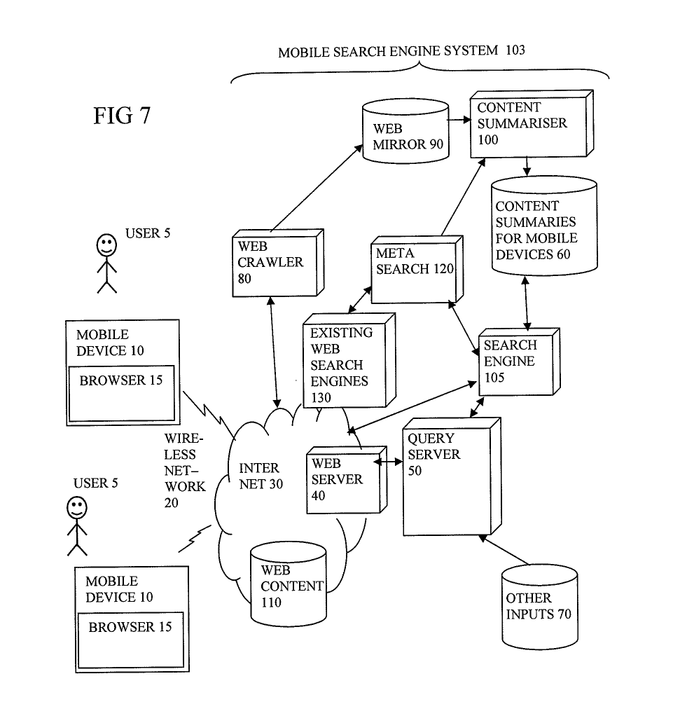

A user click on item 630 leads to a new search results list screenview as shown. A user click on item 640 leads to a new screenview or page of suggested search queries relating to the second search result and to category A. Other layouts for the various screenviews can be envisaged. Again the first and further screenviews can be downloaded together as a package without waiting to see which are selected, or each can be downloaded on demand only when they are selected. The summary text and thumbnail image to provide more information about the second or any search result can be created offline or created on the fly from the source content such as a source web page for example. FIG. 7 shows an example of a topology of a system arranged to generate and store suitable content summaries from source web pages.

Having the results spread over a number of screenviews with selectable links can help a user to navigate through the results more quickly or more easily. This can help reduce the number of clicks needed to find an item of interest, or enable more items to be sent and browsed. It exploits the fact that browsers on mobile devices typically support a user input device such as an up/down/left/right key, joystick, pointer or wheel, for moving a display focus or cursor or selecting a highlighted option. A user of the browser can navigate between the pages and each result page can itself be scrolled if necessary. Such scrolling can be limited to that page and so be limited to a screenview or one or more results so that a user can hold a scroll button down to scroll rapidly without the inconvenience of scrolling past the next result or screenview.

Another consequence of page boundaries is that each result page can use all 12 access keys (keypad shortcuts to hyperlinks) on a conventional numeric keypad of a handheld device, whereas if all results are in one page, the set of 12 keys can only be used once across all the results. Again this can enable faster navigation through the results.

Another consequence of page boundaries is that each page can use the title bar displayed in many mobile browsers (set by the <title> XHTML tag), where previously one title had to be shared by all results. Particularly for handheld device displays with typically 10 to 15 lines of text, it is useful if an extra line can display useful information, such as information specific to results being displayed.

Another consequence of page boundaries is that navigation between pages can be arranged in XHTML more naturally with standard page links as opposed to the less reliably implemented (varies from browser to browser) bookmark, or anchor, links within the same page. Proper page links also means the browser back button works perfectly.

### FIG. 7 Topology for Generating Content Summaries

FIG. 7 shows an overview of some principal entities of a search engine system, according to an embodiment suitable for generating content summaries. This figure shows many of the items shown in FIG. 1 and reference is made to the description of FIG. 1. In addition it shows a content summariser 100, a database 60 of content summaries, a web mirror 90, and web crawler 80. The query server is arranged to generate search results by looking first in the database 60 of content summary objects, and in addition or instead, use one (or more) existing web search engines 130 via a meta search engine 120. Meta search engines are well known and available commercially. Typically they will return a ranked search results list of URLs with or without an extract of text in response to the search query.

The database of content summary objects (CSOs) can be built up by the content summariser 100, from a web mirror 90. The web mirror holds a copy of online content found by a web crawler 80. Alternatively CSOs can be created from data derived from 3^{rd} party databases or from RSS feeds, or from other sources. The content summaries are typically extracts of important information from web pages, designed to be more suitable for sending across limited bandwidth networks, and for viewing or presenting on small screens of mobile devices. They may also be summaries of a WAP page, able to be displayed within a single screenview. More details of examples of CSOs are set out below.

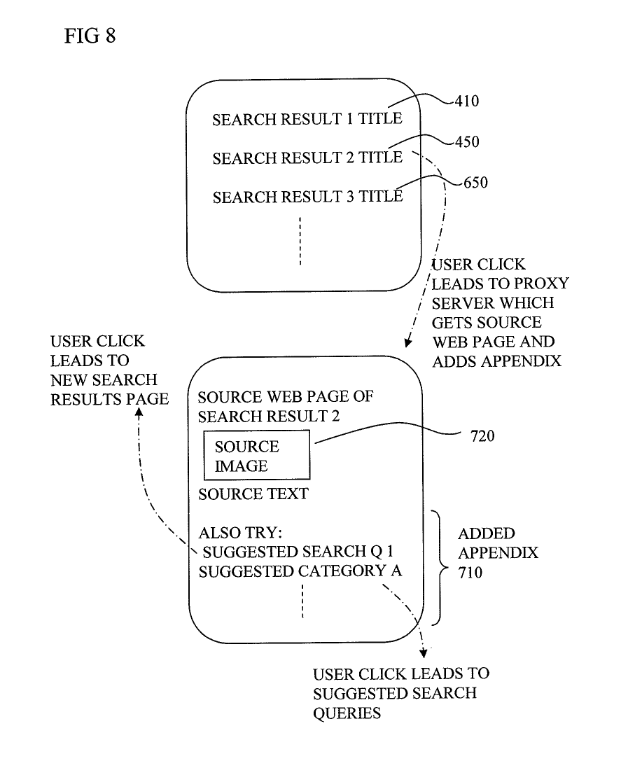

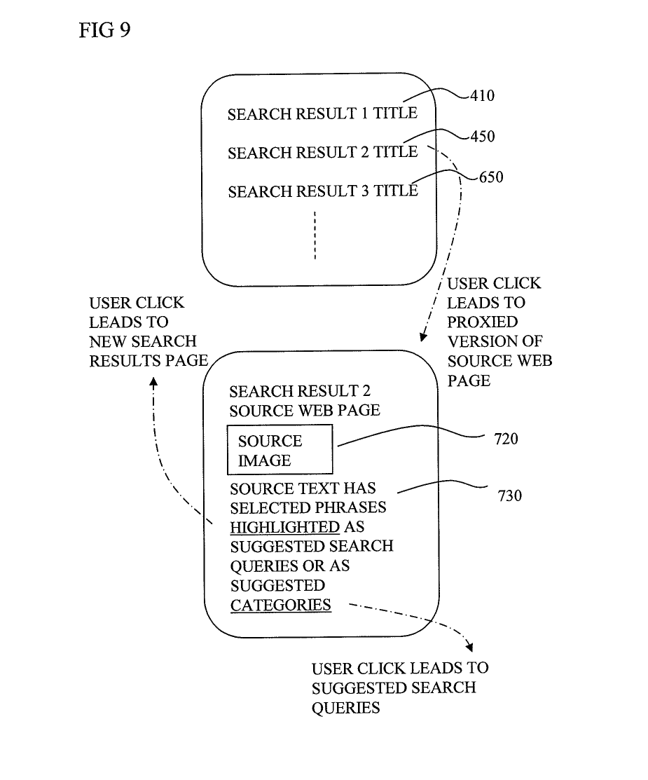

FIGS. 8 and 9, Incorporating Suggested Search Queries into Source Content,

FIG. 8 shows a schematic view of a sequence of mobile device screenviews according to another embodiment in which the suggested search queries are incorporated into a source webpage by a proxy server. A first screenview shows a list of first, second and third search result titles 410, 450 and 650, and there may be more according to the size of the screenview. A user click on the second of these leads to the lower screenview. The lower screenview is generated by a proxy server which gets the source content and adapts it by adding the suggested search queries before sending it on to the user's device.

The lower screenview shows a separate page or window in which is presented the source web page for the second search result. In this case there is a source image 720 and source text. An appendix 710 is shown added below, having an item indicating “also try first suggested search query, or suggested search category A”.

As before, a user click on the first suggested search query leads to a new search results list screenview as shown. A user click on the suggested search category A item leads to a new screenview or page of suggested search queries relating to the second search result and to category A. Other layouts for the various screenviews can be envisaged. FIG. 9 shows a schematic view of a sequence of mobile device screenviews according to another embodiment in which the suggested search queries are incorporated into the source webpages, and appear as highlighted phrases in the source text. This is similar to FIG. 8, and similar reference numerals have been used as appropriate. In this case, instead of appending the suggested search queries, they appear incorporated in the source content text 730, and are highlighted in some way such as underlining as shown. A user can then rapidly and easily identify relevant search queries or categories while reviewing the details of the source content of the second search result. Items that are categories which lead to lists of suggested search queries being presented may be highlighted in a different way than items that are themselves a suggested search query. This scheme requires the modification of the source page which requires the search service to act as a proxy server. The search service, instead of serving links directly to the source website, would serve result links to its own site, and then fetch the source page on behalf of user, modify it and serve it on to the user. The modification would be the addition or insertion of the suggested search links.

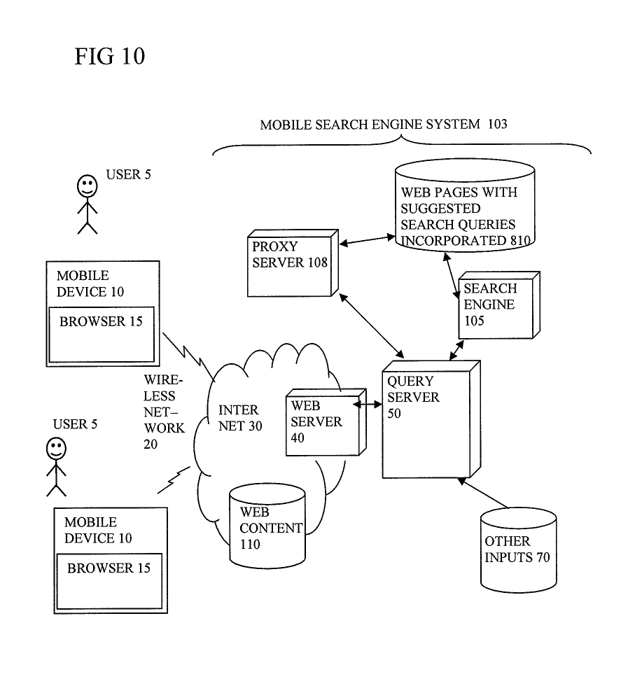

FIGS. 10, 11, 12 Incorporating Suggested Search Queries into Source Content

FIG. 10 shows an overview of a topology showing some principal entities of a search engine system, according to an embodiment. Many parts are similar to FIG. 1 and reference is made to the description of FIG. 1. In addition a proxy server 108 is provided, coupled to the query server. The proxy server is arranged to get the source content and serve or store the altered source content such as web pages. These can be stored in a store 810.

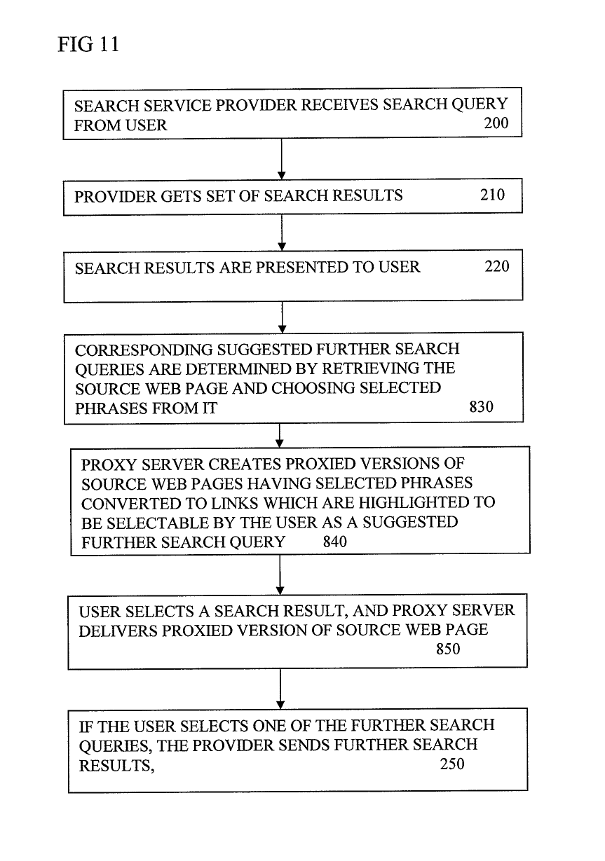

FIG. 11 shows some principal actions of a service provider according to an embodiment involving generating a proxy of a source web page. The first few steps are similar to those in FIG. 2. At step 200 the search service provider receives the search query from the user. At step 210 the provider gets the search results. As indicated above this can either involve a dedicated search engine or can use third party search engines for example. At step 220, suggested further search queries corresponding to the search results are derived. This can be carried out by the query server for example. Then at step 830 corresponding suggested further search queries are determined by retrieving the source web page and choosing selected phrases from it. The proxy server creates proxied versions of source web pages having selected phrases converted to links which are highlighted to be selectable by the user as a suggested further search query at step 840. The user then selects a search result, and proxy server delivers the proxied or altered version of source web page at step 850. If the user selects one of the further search queries, the provider sends further search results at step 250.

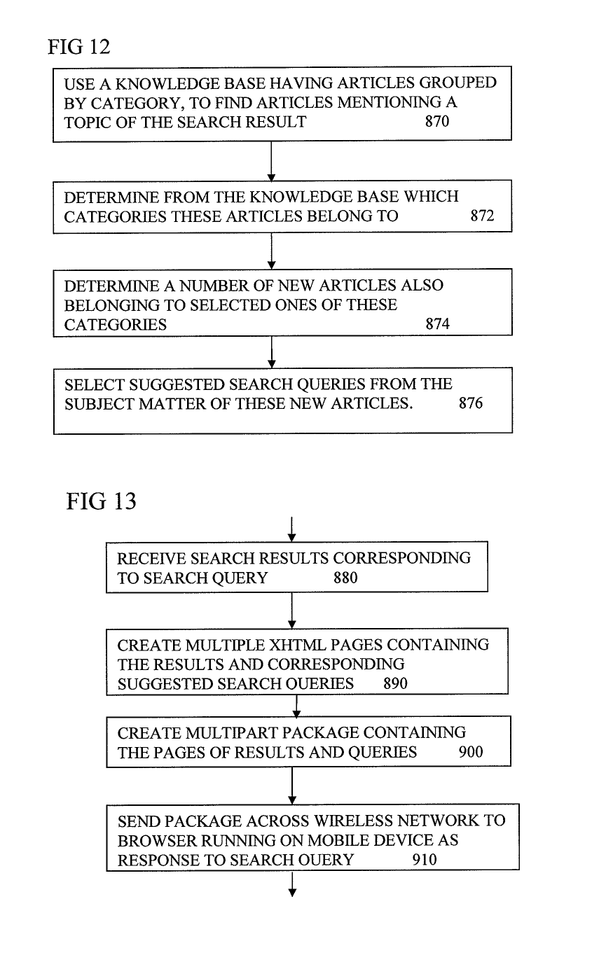

### FIG. 12 Generating Suggested Search Queries

FIG. 12 shows an example of steps involved in generating suggested search queries according to an embodiment. This can involve the query server or other part carrying out steps of using a knowledge base having articles grouped by category, to find articles mentioning a topic of the search result at step 870. It determines from the knowledge base which categories these articles belong to at step 872. At step 874 it determines a number of new articles also belonging to selected ones of these categories. Then it selects suggested search queries from the subject matter of these new articles at step 876. An example of a knowledge base is the Wikipedia website, and many others can be envisaged. For example if a first search result is a football website, an article about football might be found in the database. It might be in a category of ballsports, and other articles in the same category might include rugby or handball.

Other ways of generating suggested search queries can be envisaged, such as taking parts of the title or meta data from the search result.

### FIGS. 13,14, Multipage Package

To reduce the frustrations of the delays implicit in mobile networks, the query server can be arranged to send a package of multiple pages of results which can be browsed by a user without needing multiple request and download cycles. As shown in FIG. 13, the query server at step 880 receives search results corresponding to the query. At step 890, the server creates multiple pages defined in a mark up language such as XHTML or HTML, containing the results, and corresponding suggested search queries. At step 900, the server creates a package containing the pages of results. At step 910 the package is sent across the wireless network to the browser running on the mobile device, as a response to the search query. Many variations and additional steps can be added to these basic operations of the query server.

Some of the principal operations at the user side are shown in FIG. 14. A user selects a search option, and the browser running on the mobile device typically displays a search query entry form. At step 920, a user enters a search query into the browser. The browser forwards the query as a page request to the search engine system. (In principle the query could be entered elsewhere such as a desktop computer, for sending results to the mobile device). The browser receives the package and displays a first page at step 925. At step 930, the user can browse through the pages of results using page up or page down or other page selection inputs, such as inter page hyperlinks, without the need for a download across the wireless network for each page. At step 935, if needed, the user can select a hyperlink to download content based on the search results, or can select one of the suggested search queries and download further search results. Again there can be many variations and additional steps. Embodiments can be implemented using all the components described in more detail in the previous applications “Processing and Sending Search Results over a Wireless Network to a Mobile Device” and “Display of Search Results on Mobile Device Browser with Background Process”, but with a server component that packages the results up as a multiple page package instead of a single XHTML page.

One type of package which is currently supported by many browsers on mobile devices is multipart MIME. It is known to use MIME to extend the format of Internet email to allow non-ASCII textual messages, non-textual messages, multipart message bodies, graphics, images and so on in message headers. MIME are a set of standards defining a message representation protocol. These standards have grown up since 1982 through a number of RFC's (Request for Comments). Notable amongst these are Aug. 1982 RFC822 Standard for the format of ARPA Internet Text Messages, Sept. 1993 RFC1521 Mechanisms for Specifying and Describing the Format of Internet Message Bodies, and more recently RFCs 2045 to 2049. Multipart MIME is a standard used for MMS (Multimedia messages) as a way of transmitting multiple objects of differing types in a single package. It is not used at all for desktop browsing, but many microbrowsers for handheld mobile devices do support multipart MIME packages. At least some of the embodiments exploit a recognition that multipart MIME packages which are currently used in mobile browsing for packaging a single XHTML page with any images it uses, can be used for other purposes.

By having multiple XHTML pages contained within a single multipart MIME structure, together with all the images that all the pages need, search results can be presented on many mobile devices without always needing a custom application, and with a reduced number of download delays.

Compared to having all the results in “one big page” as described in above referenced earlier applications, multiple pages contained within a single multipart MIME structure has a number of consequences or advantages as has been discussed above. At least some of the results can be displayed one per page. This can equate to a screenview, or the page boundaries can be smaller or larger than a screenview. If each result is displayed in a true page, this means that:
each result page can itself be scrolled if necessary, where that scrolling is limited to that result and doesn't confusingly let the user move into the next result,
each result page can use all 12 access keys (keypad shortcuts to hyperlinks) where previously the set of 12 keys was shared across all sections of the “one big page”,
each result page can use the title bar displayed in many mobile browsers (set by the <title> XHTML tag), where previously one title had to be shared by all results,
navigation between pages can be arranged in XHTML more naturally with standard page links as opposed to the less reliably implemented (varies from browser to browser) bookmark, or anchor, links within the same page. Proper page links also means the browser back button works perfectly.

Another notable combination is multi-page packages and results in the form of content summary objects. As discussed above, content summary objects can provide more dense information, and more relevant information than the source online content. This combination can help reduce the number of download cycles when browsing results of a search query by receiving results on a wireless device. The package can include a content summary for each item of the search results, including multimedia items and a number of other features to make browsing more rapid or convenient, especially to overcome physical limitations of handheld mobile devices with limited capabilities for display or for scrolling or selecting, and the physical limitations of the wireless network. This will be referred to as a content summary package (CSP). The package can be arranged as a page extending over a number of browsable screenviews. This can provide more information and/or a more convenient arrangement for browsing, compared to the normal annotated result list provided by traditional search engines. The quantity and presentation of the summary of each content item can be tailored to suit the device to best take advantage of the mobile device physical format. For example each content summary could be arranged to fill a small format screen of a handheld mobile device. The content summarized can be Web pages, WAP pages, news items, sound or video clips or many other types of content for example. By providing a richer and better-structured summary than existing mobile search engines, a user can find a desired or optimum page more quickly. Particularly where background processes can be used to enable more rapid browsing of many summaries, the mobile search can be more efficient and less frustrating for the user.

A set of navigable pages is one possible presentation format of a content summary package, useful to take advantage of widespread use of browser software to read hypertext pages in mark up languages, such as the standard XHTML microbrowser built into many mobile device. If this is the chosen presentation format, then the screenview is the currently visible part of the package, and may correspond to the presentation format of an individual content summary.

Other presentation formats are possible, using for example a custom Java application client downloaded onto the device. In this case, a content summary package can be formed within an XML document or even within a binary file format, and individual content summaries could be expressed likewise as (smaller) XML documents or binary files.

Screenviews are intended to encompass a portion of a web page (or other page based display medium) suitable for display by a browser or equivalent software on a mobile device. The size of a screenview can be determined dynamically by discovering the actual size of the display of the device being used, or by taking a default value based on estimates or typical devices used most frequently. A margin can be provided around the screenview to allow for different actual display sizes. The content summary sizes can be chosen to substantially fill a screenview of the mobile device. A next screenview can be selected by a user for display by scrolling, or more conveniently in some embodiments by using a hyperlink. Users can access a start point of the information by clicking on a button or a hypertext link embedded elsewhere in the web page. This is often much more convenient than scrolling, which is too time consuming if there are multiple screenviews to scroll through, or if it is desired to flick backwards and forwards between an overview and content summaries for example.

The package of screenviews can be implemented as a set of pages in XHTML Mobile Profile for example. As indicated by the W3C website, XHTML Mobile Profile is one in a series of XHTML specifications. The XHTML Mobile Profile document type includes the minimal set of modules required to be an XHTML Host Language document type, and in addition it includes images, forms, basic tables, and object support. It is designed for Web clients that do not support the full set of XHTML features; for example, Web clients such as mobile phones, PDAs, pagers, and settop boxes. The document type is rich enough for content authoring. XHTML Mobile Profile is designed as a common base that may be extended by additional modules from XHTML Modularization such as the Scripting Module. Thus it provides a common language supported by various kinds of user agents such as browsers. It is useful if the page format can be read and presented by many different versions of “legacy” browsers to maximize the user base among existing mobile telephone users for example.

An overview of search engine activities can be summarized as follows:
Spider the Web as conventional search engines do.
Extract content summaries from each web page based on a category of content found on that page (e.g. text, image, video)
Store and index summaries in an indexed database.
Receive a query, obtain search results from the indexed database.
Generate suggested search queries corresponding to the search results.
Incorporate the suggested search queries with a visual representation of the correspondence,
Customize the display of the content summaries to the mobile device and/or its browser,
Send a set of summaries to user as a package for a browser to present, optionally include advertising material and other information of potential interest, together with code for background processes.
Display using browser on the mobile device, starting with a short overview of items in the results, optionally including an entry to the advertising material, using background processes to reduce delays.
Subsequently display each larger summary in response to input such as clicking on a URL, on a button, or scrolling by the user.

This can help overcome problems such as mobile devices having small screen sizes, and XHTML being limited in capability. It need not be limited to particular mobile device characteristics or browser. It helps overcome the problem that network fetches are time-expensive, and that even newer faster networks will suffer from congestion at peak times and show latency effects.

The generation of these content summaries can be carried out offline or on demand, or some combination of these options. If done offline, they can be stored in an indexed database which is integrated within an overall search engine architecture, so that the summaries may be more rapidly retrieved in response to a user query. If the summaries are generated on demand, this requires following the links in search results obtained from existing search engines, to obtain the whole content items, such as web pages. The system can optionally be set up as a metacrawler acting as a front end to existing search engines. The summaries can then be created from the whole content items obtained from multiple search engines.

Embodiments can provide a minimum system which streamlines the process of mobile search. It can be implemented as a metacrawler in front of existing search engines (e.g. Google™, Yahoo™, MSN™) or as a subsystem which is more tightly integrated into an overall search engine system. An additional level of summarisation of the original content items (whether they be Web pages, WAP pages, news items, sound or video clips, or local information such as e.g. yellow pages or white pages) can be created in addition to the normal annotated results list provided by search engines like Google. It transmits these content item summaries to the mobile device as a single-shot package (a content summary package or CSP) in response to a keyword-initiated search.

The additional level of content summaries gives the user sufficient information about the content he/she is seeking that he can have high confidence in it before clicking through to the underlying content item on the WWW. The system allows the mobile user to quickly navigate through a set of content summaries cached within the local device browser to find what they are looking for, without the need to incur expensive clicks over the mobile network. In this way the user experience of mobile search can be dramatically improved.

CSPs can be implemented as HTML, XHTML Mobile Profile or XHTML Basic web pages, using either bookmarks or multipart messages, allowing the result set to be arranged as a stack of linked screenviews in the form of navigable pages.

The content summary package can be in a format suitable for the native browser on the device, or can use or include a separate software program running as a user application on the device. A number of content summarisers can be provided for creating the content summaries, each for a different category or type of content. For example one content summariser produces web page content summaries, another produces WAP content summaries, another produces video content summaries, another produces music content summaries, another produces news content summaries, and so on. A useful source of information for creating these content summaries are microformats, RDF files and other information contributing to the so-called semantic web.

These content summaries can be stored as content summary objects (CSOs) and stored in databases which are indexed. The indexes are consulted when the query server 50 searches for relevant content summaries. The content summaries found are fed to the query server for incorporating into a package. A store of device information and a store of user history can be provided to enable the query server to tailor the package. The query server can create the overview screenviews from the content summaries.

The content summary database or index to it can store meta-data about its respective content item or the web page holding that item as follows. Such meta data might constitute one, some or all of the following aspects of a media item:
size
image/frame dimensions
length in time
CRC (cyclic redundancy check) over part or all of data
Embedded meta data, eg: header fields of images, videos etc
Media type, or MIME-type

The overview can be a conventional annotated list having brief descriptive information of up to 60 or so words on each item, plus other descriptive information such as the source web site, date, etc, or can be provided in other forms such as a non-annotated list, a list of groups of items, a multilevel list, capable of showing more or less information about each item or groups of items, or an array of thumbnail images, or a scrolling sequence of views of successive items, for example.

### Content Summaries

A content summary can encompass an aspect of a web page (from the world wide web or intranet or other online database of information for example) that can be distilled/extracted/resolved out of that web page as a discrete unit of useful information. It is called a summary because it is a truncated, abbreviated version of the original that is understandable to a user.

### Example Types of Content Summary Include (but are not Restricted to) the Following:

Web page text—where the content summary would be a contiguous stretch of the important, information-bearing text from a web page, with all graphics and navigation elements removed.
WAP pages—where the summary would be the first dozen or so lines of a WAP page, including any images (since the images are small and already optimized for display on a mobile device).
News stories, including web pages and news feeds such as RSS—where the content summary would be a text abstract from the original news item, plus a title, date and news source.
Images—where the content summary would be a small thumbnail representation of the original image, plus metadata such as the file name, creation date and web site where the image was found.
Ringtones—where the content summary would be a starting fragment of the ringtone audio file, plus metadata such as the name of the ringtone, format type, price, creation date and vendor site where the ringtone was found.
Video Clips—where the content summary would be a small collection (e.g. 4) of static images extracted from the video file, arranged as an animated sequence, plus metadata

The collection of summaries is obtained by scanning the WWW and is then indexed and made available to the search service. The items scanned can include items from the deep web, that is dynamically generated web pages generated from live databases behind the web page, such as weather forecasts, travel timetables, stock quotes and so on. Search queries result in a collection of relevant content summaries being returned to the user.

A notable advantage of obtaining, storing and sending results in content summary units rather than page units is that they can be adapted to different screen sizes more easily to make better use of the confines of the limited screen real-estate of a typical hand held mobile device. Further, the presentation of content summaries such as size, font size, colors or media types used for example, can be tailored depending on the characteristics (browser, screen colour depth and size, video capability, ringtone capability etc) of the user's device. The package size can also be tailored to suit the browser of the device, or characteristics of the wireless channel, such as bandwidth, latency or quality. For example an operator of the wireless network might have a network management system with live information about the currently available bandwidth or other channel characteristics for each connection. This could be passed to the query server, to enable it to dynamically decide how large the next package on that connection can be, and so decide how many content summaries or how large each summary can be without the user noticing undue delay. Furthermore, the size of a screenview can be adapted, to suit an actual display size or other factor for example. This might affect where hyperlinks are located in the page, if it is desired to present hyperlinks at the same place in each screenview, for ease of use.

This tailoring might be achieved by storing the content summaries in a device neutral representation (which could be XML but doesn't have to be) and then transforming them (possibly with XSLT) either on the fly (per request depending on the user's device) or preparing transformed content summaries in advance.

A second advantage to content summaries is that several can be collated together to form a package containing a number of screenviews, in other words a single CSP that can be transmitted more efficiently to a wireless device. This means that several results can be downloaded to a device whilst only incurring one instance of the network latency. The user can quickly scroll, or page, through the result set. This is in contrast to traditional search results that require the user to click on each search result and wait for it to download before being able to glean any information or determine that the result was not relevant. These features can be combined with using a formatting template as described above which can be reused, to provide further options for altering the screenview by swapping new data into the page.

Content summaries can be grouped into categories, e.g. images, webtext, ringtones, videoclips, news items, addresses. Such categories can be based on content categories or on media type. Categories can be used to assist in the presentation of sets of results to a search query. The user could be offered the choice of category of result before being presented with the results of a particular category. Alternatively, the user could have already expressed a preference (either via their mobile device, or using a desktop to access their mobile-search account preferences), and results from the user's preferred category presented first.

Content summaries can be extracted from web pages containing any machine readable content format. This includes all flavours of HTML, JavaScript, FLASH, PDF, Microsoft Office documents etc. Content summaries might be the whole page if the page is small and has a high information density, or it might just be a small subset of the content of the page.

Content summaries might be inserted by other means than by automated scanning (crawling) of the web. E.g. by manual insertion or custom conversion of third party databases. Content summaries are primarily a way of storing units of information that can be collated and displayed conveniently on a mobile device. A good application of these is in the implementation of a web search service for mobile devices where a lack of alternative means of finding and displaying the information exists. A second application is in access of an online store or marketplace (e.g. Ebay™) where a mobile user wishes to search for a multitude of candidate items to bid on or purchase.

Individual content summaries can be linked within Summary Packages using intra-page hyperlinks (called bookmarks in HTML, XHTML Basic and XHTML Mobile Profile). Clicking on a bookmarked link is then just a jump in the view of the current page and does not involve the browser returning to the network to fetch the next page. The user receives this Summary Package (actually a stack of web screenviews) in a single network fetch-response cycle and can then browse through the contained results with quick clicks on the intra-page links.

In XHTML Mobile Profile the anchor tag <a> with the href attribute set to a bookmark can be used to implement this method. The effect of this navigation method is to enable page-by-page scrolling rather than the pixel-by-pixel or line-by-line scrolling normally offered via the device's up/down/left/right navigation keys.

Bookmarks are a standard and well understood technique in desktop web pages. They are normally used to offer fast links to specific sections of a large documents. However, bookmarks have not often been used to link consecutive screenfuls of content—this being especially useful on a mobile device which typically has a reduced keyboard with no page up or page down key, as well as a small format display.

Content Summaries are a very convenient unit for each screenview in a linked stack of search results. Each screenview is then a candidate result item for the search query, and the set of results can be stepped through with a quick-to-load (because it's just a move) click per result. This clicking can step through results of different types (for example different media categories such as text or images) simply by arranging for the stack of content summaries (screenviews) to come from these different categories.

CSPs can incorporate sponsored links similar to those used in the desktop search service environment. Where the advertiser has mobile-specific webpages, these sponsored links can point directly at these pages. However, where an advertiser does not have mobile-specific web pages, they can instead provide advertising collateral to the search service. For each content summary item, a hyperlink having a URL can be provided to let the user click down to the underlying content item found on the WWW. Each and every page in this system can have a single AdLink. When a user clicks on an AdLink, an AdPage is presented, which is a textual page which is carried in the payload of the search query response page. A link at the bottom of the AdPage is provided to make a request over the wireless network to load further advertising material.

Any of the additional features can be combined together and combined with any of the aspects. Other advantages will be apparent to those skilled in the art, especially over other prior art.

1. A method of providing a computer based search service having the steps of:
providing a set of search results in response to a search query from a user,
providing one or more suggested search queries, for selection by the user to generate more search results, at least one of the suggested search queries having a correspondence with a corresponding subset of one or more of the search results, and sending to the user the set of search results, with an indication of the corresponding suggested search queries, for presentation to the user with a visual representation of the correspondence.

2. The method of claim 1, for providing the service to a mobile device of the user, and the step of causing the presentation to the user comprising causing the mobile device to present to the user.

3. The method of claim 1, for providing a web based search service, and the step of causing the presentation to the user comprising sending a page to be rendered by a browser running on a computing device of the user.

4. The method of claim 1, the visual representation of the correspondence involving placing suggested search queries adjacent to their corresponding search result.

5. The method of claim 1, having the step of sending at least some of the search results for presentation on separate screenviews, and placing the corresponding suggested search queries on the same screenview as their corresponding search result.

6. The method of claim 1, having the step of determining a correspondence by any one or more of: determining whether the search query was derived from the search result, or derived from a source of the result, whether the suggested search query is based on a subset of the topics of the search result, or whether the respective topics of the suggested search queries and the search result have any common root.

7. The method of claim 1, the step of providing suggested search queries involving using a knowledge base having articles grouped by category, to find articles mentioning a topic of the search result, determining from the knowledge base which categories these articles belong to, then determining a number of new articles also belonging to selected ones of these categories, and selecting suggested search queries from the subject matter of these new articles.

8. The method of claim 1, the indication of corresponding suggested search queries comprising a link selectable by the user to lead to presentation of a group of suggested search queries.

9. The method of claim 1, having the step of generating suggested search queries by selecting a portion of text from the corresponding search result.

10. The method of claim 9, the visual representation of the correspondence comprising text of the search result with the selected portion or portions of the text in their original position in the text and highlighted so as to indicate that the portion is selectable by the user to cause a further search.

11. The method of claim 1, the step of sending the search results to the user involving retrieving source content of the given result, and sending to the user a proxied version of the source content, the proxied version being altered to incorporate corresponding ones of the suggested search queries.

12. A server arranged to provide a computer based search service and having:
a part arranged to provide a set of search results in response to a search query from a user,
a part arranged to provide one or more suggested search queries, for selection by the user to generate more search results, at least one of the suggested search queries having a correspondence with a corresponding subset of one or more of the search results, and a sending part arranged to send to the user the set of search results, with an indication of the corresponding suggested search queries, for presentation to the user with a visual representation of the correspondence.

13. A program on a computer readable physical medium and which when executed provides a computer based search service having the steps of:
providing a set of search results in response to a search query from a user,
providing one or more suggested search queries, for selection by the user to generate more search results, at least one of the suggested search queries having a correspondence with a corresponding subset of one or more of the search results, and sending to the user the set of search results, with an indication of the corresponding suggested search queries, for presentation to the user with a visual representation of the correspondence.

14. The program of claim 13, for providing the service to a mobile device of the user, and the step of sending to the user causes the mobile device to present the search results to the user with the visual representation of the correspondence.

15. The program of claim 13, for providing a web based search service, and the step of causing the presentation to the user comprising sending a page to be rendered by a browser running on a computing device of the user.

16. The program of claim 13, the visual representation of the correspondence involving placing suggested search queries adjacent to their corresponding search result.

17. The program of claim 13, having the step of sending at least some of the search results for presentation on separate screenviews, and placing the corresponding suggested search queries on the same screenview as their corresponding search result.

18. The program of claim 13, having the step of determining a correspondence by any one or more of: determining whether the search query was derived from the search result, or derived from a source of the result, whether the suggested search query is based on a subset of the topics of the search result, or whether the respective topics of the suggested search queries and the search result have any common root.

19. The program of claim 13, the step of providing suggested search queries involving using a knowledge base having articles grouped by category, to find articles mentioning a topic of the search result, determining from the knowledge base which categories these articles belong to, then determining a number of new articles also belonging to selected ones of these categories, and selecting suggested search queries from the subject matter of these new articles.

20. The program of claim 13, the indication of corresponding suggested search queries comprising a link selectable by the user to lead to presentation of a group of suggested search queries.

21. The program of claim 13, having the step of generating suggested search queries by selecting a portion of text from the corresponding search result.

22. The program of claim 21, the visual representation of the correspondence comprising text of the search result with the selected portion or portions of the text in their original position in the text and highlighted so as to indicate that the portion is selectable by the user to cause a further search.

23. The program of claim 13, the step of sending the search results to the user involving retrieving source content of the given result, and sending to the user a proxied version of the source content, the proxied version being altered to incorporate corresponding ones of the suggested search queries.

24. A method of using a mobile search service having the steps of: sending a search query to the mobile search service, receiving at a browser running on a mobile device, a set of search results, with an indication of corresponding suggested search queries, and using the browser to present the search results with a visual representation of the correspondence.

25. The method of claim 24 having the step of causing the browser to send to the search service an indication of which of the suggested search queries is selected, and causing the search service to send further search results based on the selected search query.
